(19) United States
(12) Patent Application Publication
(10) Pub. No.: US 2024/0402711 A1
(43) Pub. Date: Dec. 5, 2024

(54) MOVING OBJECT, REMOTE CONTROL SYSTEM, AND REMOTE CONTROL METHOD

(71) Applicant: TOYOTA JIDOSHA KABUSHIKI KAISHA, Toyota-shi (JP)

(72) Inventors: Kento Iwahori, Nagoya-shi (JP); Keigo Ikeda, Nisshin-shi (JP); Daiki Yokoyama, Miyoshi-shi (JP)

(73) Assignee: TOYOTA JIDOSHA KABUSHIKI KAISHA, Toyota-shi (JP)

(21) Appl. No.: 18/665,293

(22) Filed: May 15, 2024

(30) Foreign Application Priority Data
Jun. 5, 2023 (JP) 2023-092440

(51) Int. Cl. G05D 1/221; G05D 1/69; G05D 109/10; G05D 111/30

(52) U.S. Cl. CPC G05D 1/221; G05D 1/69; G05D 2109/10; G05D 2111/30

(57) ABSTRACT

A moving object operable by remote control includes a detection unit configured to detect a signal transmitted from a control device for remotely controlling the moving object; and a control signal acceptance unit configured to switch to either an activation state of accepting a control signal transmitted from the control device for remotely controlling the moving object or a deactivation state of not accepting the control signal, wherein the control signal acceptance unit switches to the activation state when the signal is detected by the detection unit.

### CROSS REFERENCE TO RELATED APPLICATIONS

This application claims priority to Japanese Patent Application No. 2023-092440, filed Jun. 5, 2023, the disclosure of which is incorporated by reference herein in its entirety.

### BACKGROUND

### Field

The present disclosure relates to a moving object, a remote control system, and a remote control method.

There are known techniques of causing vehicles to run by remote control during vehicle manufacturing steps (for example, Japanese Patent Application Publication (Translation of PCT Application) No. 2017-538619).

When a vehicle is shipped with the remote control deactivated, it is preferable that the remote control of the vehicle can be activated without taking labor in order to enhance convenience of the user who wants to remotely control the vehicle. Accordingly, a technique of enabling activation of the remote control without taking labor is desired.

### SUMMARY

The present disclosure can be implemented as the following aspects.

(1) According to a first aspect of the present disclosure, a moving object operable by remote control is provided. The moving object includes a detection unit configured to detect a signal transmitted from a control device for remotely controlling the moving object; and a control signal acceptance unit configured to switch to either an activation state of accepting a control signal transmitted from the control device for remotely controlling the moving object or a deactivation state of not accepting the control signal, wherein the control signal acceptance unit switches to the activation state when the signal is detected by the detection unit.

According to the moving object of this aspect, the control signal acceptance unit automatically switches to the activation state when the signal transmitted when the control device is in operation is detected by the detection unit, which thus allows the moving object to be operable by remote control without taking labor.

(2) In the moving object of the above aspect, the signal may be a control signal for remotely controlling another moving object different from the moving object.

According to the moving object of this aspect, the control signal acceptance unit automatically switches to the activation state when the control signal transmitted from the control device for remotely controlling the other moving object is detected by the detection unit, which thus allows the moving object to be operable by remote control without taking labor.

(3) The moving object according of the above aspect may further include a notification unit configured to transmit a notification signal for notifying the control device that the control signal acceptance unit has switched to the activation state.

According to the moving object of this aspect, it is possible to notify the control device that the moving object has become operable by remote control.

(4) According to a second aspect of the present disclosure, a remote control system is provided. The remote control system includes a moving object operable by remote control; and a control device for remotely controlling the moving object, wherein the moving object includes, a detection unit configured to detect a signal transmitted from the control device, a control signal acceptance unit configured to switch to either an activation state of accepting a control signal transmitted from the control device for remotely controlling the moving object or a deactivation state of not accepting the control signal, wherein the control signal acceptance unit switches to the activation state when the signal is detected by the detection unit, and a notification unit configured to transmit a notification signal for notifying the control device that the control signal acceptance unit has switched to the activation state, and wherein the control device prepares or starts remote control for the moving object when receiving the notification signal.

According to the remote control system of this aspect, remote control of the moving object can be prepared or started by the control device when the moving object becomes operable by remote control.

(5) According to a third aspect of the present disclosure, a moving object operable by remote control is provided. The moving object includes a detection unit that detects a signal transmitted when a control device that remotely controls the moving object is in operation; a notification unit that transmits a notification signal of notifying the control device of a presence of the moving object when the signal is detected by the detection unit; and a control signal acceptance unit that switches to either an activation state of accepting a control signal transmitted from the control device for remotely controlling the moving object or a deactivation state of not accepting the control signal, and that switches to the activation state when receiving an activation signal transmitted from the control device according to the notification signal.

According to the moving object of this aspect, the control signal acceptance unit automatically switches to the activation state according to the activation signal transmitted from the control device, which thus allows the moving object to be operable by remote control without taking labor.

(6) According to a fourth aspect of the present disclosure, a remote control system is provided. The remote control system includes the moving object of the above aspect, and a control device that remotely controls the moving object and that transmits the activation signal to the moving object when receiving the notification signal.

According to the remote control system of this aspect, it is possible to transmit the activation signal from the control device to the moving object.

(7) According to a fifth aspect of the present disclosure, a remote control method is provided. The remote control method includes detecting a signal transmitted from a control device for remotely controlling a moving object; and switching to either an activation state of accepting a control signal transmitted from the control device for remotely controlling the moving object or a deactivation state of not accepting the control signal, switching switches to the activation state when the signal is detected by detecting.

According to the remote control method of this aspect, it is possible to allow the moving object to be operable by remote control in a simplified manner and without taking labor.

(8) According to a sixth aspect of the present disclosure, a remote control method is provided. The remote control method includes a detection step of detecting a signal transmitted when a control device that remotely controls a moving object operable by remote control is in operation; a notification step of transmitting a notification signal of notifying the control device of a presence of the moving object when the signal is detected; and a switching step of switching from an activation state in which the moving object accepts a control signal transmitted from the control device for remotely controlling the moving object to a deactivation state in which the moving object does not accept the control signal, and switching to the activation state when an activation signal transmitted from the control device according to the notification signal is received.

According to the remote control method of this aspect, it is possible to allow the moving object to be operable by remote control in a simplified manner and without taking labor.

The present disclosure can also be implemented in various aspects other than the moving object, the remote control system, and the remote control method. For example, the present disclosure can be implemented in aspects of a vehicle, a computer program, a storage medium storing a computer program, and the like.

### BRIEF DESCRIPTION OF THE DRAWINGS

FIG. 1 is an explanatory view illustrating a configuration of a remote control system;

FIG. 2 is an explanatory view illustrating a configuration of a vehicle;

FIG. 3A is an explanatory view illustrating how the vehicle moves by remote control in a factory;

FIG. 3B is a flowchart illustrating a procedure of running control of the vehicle in a first embodiment;

FIG. 4 is a flowchart illustrating contents of an activation process of the first embodiment;

FIG. 5 is a flowchart illustrating contents of a target addition process of the first embodiment;

FIG. 6 is an explanatory view illustrating how a remote control function of the vehicle is activated;

FIG. 7 is a flowchart illustrating contents of an activation process of a second embodiment;

FIG. 8 is a flowchart illustrating contents of a target addition process of the second embodiment; and

FIG. 9 is an explanatory view illustrating how a remote control function of the vehicle is activated.

### DETAILED DESCRIPTION

### A. First Embodiment

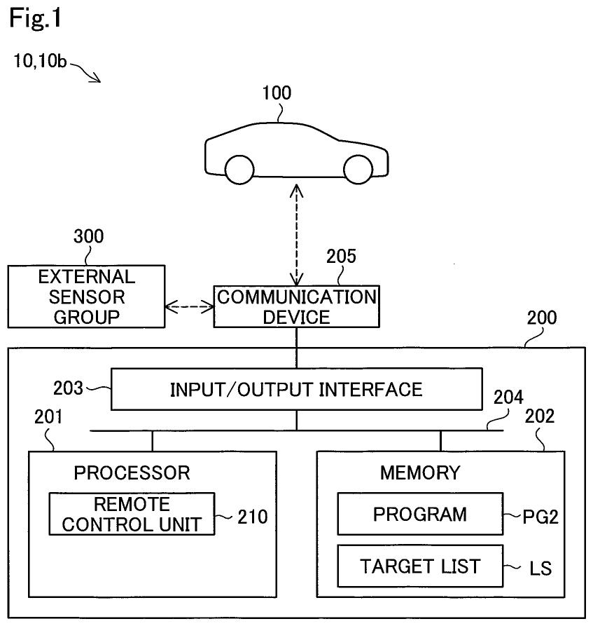

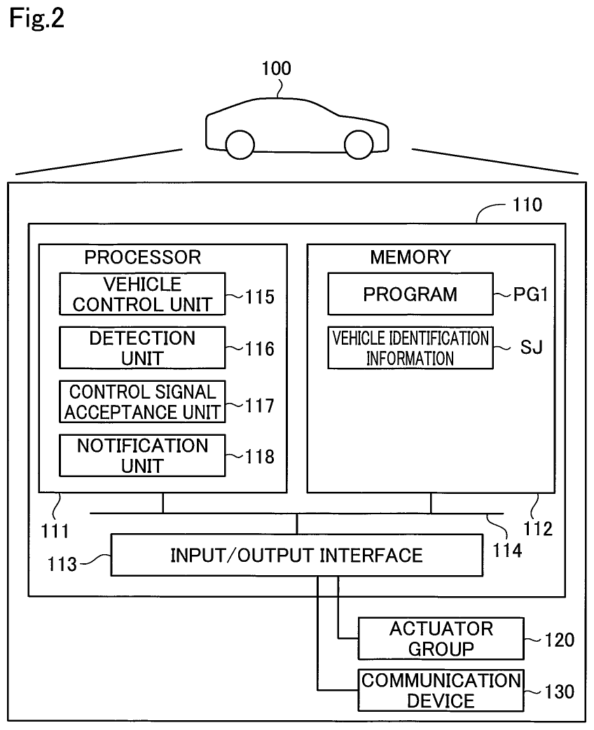

FIG. 1 is an explanatory view illustrating a configuration of a remote control system 10 in a first embodiment. FIG. 2 is an explanatory view illustrating a configuration of a vehicle 100 in the first embodiment. The remote control system 10 is used to operate a moving object by remote control.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a track, a bus, a two-wheel vehicle, a four-wheel vehicle, a construction vehicle, or a combat vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 100 is configured to be capable of running by unmanned driving. The “unmanned driving” means driving independent of running operation by a passenger. The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”

In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

As illustrated in FIG. 1, in the present embodiment, the remote control system 10 includes the vehicle 100 operable by remote control, a remote control device 200 for remotely controlling the vehicle 100, and an external sensor group 300 located outside the vehicle 100. Note that the remote control device 200 may simply be referred to as a control device.

As illustrated in FIG. 2, the vehicle 100 includes a vehicle control device 110 for controlling each of units of the vehicle 100, an actuator group 120 that drives under control of the vehicle control device 110, and a communication device 130 for communicating with the remote control device 200 via wireless communication. In the present embodiment, the actuator group 120 includes an actuator of a driving device for accelerating the vehicle 100, an actuator of a steering device for changing the traveling direction of the vehicle 100, and an actuator of a braking device for decelerating the vehicle 100. The driving device includes a battery, a driving motor driven by electric power of the battery, and a driving wheel rotated by the driving motor. The actuator of the driving device includes a driving motor.

The vehicle control device 110 includes a computer provided with a processor 111, a memory 112, an input/output interface 113, and an internal bus 114. The processor 111, the memory 112, and the input/output interface 113 are connected via the internal bus 114 such that they can bidirectionally communicate with each other. The actuator group 120 and the communication device 130 are connected to the input/output interface 113. The memory 112 stores a computer program PG1 and vehicle identification information SJ for identifying the vehicle 100. For the vehicle identification information SJ, for example, a seventeen-digit vehicle identification number (ISO 3833:1977) can be used. A reference number set by a manufacturer of the vehicle 100 may be used for the vehicle identification information SJ.

The processor 111 executes the computer program PG1 to thereby function as a vehicle control unit 115, a detection unit 116, a control signal acceptance unit 117, and a notification unit 118. The vehicle control unit 115 controls the actuator group 120. In the present embodiment, when a driver is in the vehicle 100, the vehicle control unit 115 can cause the vehicle 100 to run by controlling the actuator group 120 according to the operation of the driver. Regardless of whether a driver is in the vehicle 100 or not, the vehicle control unit 115 can cause the vehicle 100 to run by controlling the actuator group 120 according to a control signal accepted by the control signal acceptance unit 117. In the following description, viewed from the vehicle 100, the vehicle 100 itself may be referred to as an own vehicle and another vehicle 100 different from the vehicle 100 itself may be referred to as another vehicle.

The detection unit 116 detects a signal transmitted when the remote control device 200 is in operation. The signal transmitted when the remote control device 200 is in operation includes a control signal transmitted from the remote control device 200 for remotely controlling the vehicle 100. The control signal includes, for example, target values of speed and steering angle of the vehicle 100. In the present embodiment, the control signal further includes the vehicle identification information SJ. In the present embodiment, the detection unit 116 detects a control signal which the remote control device 200 transmits to remotely control another vehicle, as the signal transmitted when the remote control device 200 is in operation.

The control signal acceptance unit 117 accepts the control signal transmitted from the remote control device 200 to the own vehicle. The control signal acceptance unit 117 can determine from the vehicle identification information SJ included in the control signal whether it is a control signal transmitted to the own vehicle or a control signal transmitted to another vehicle. The control signal acceptance unit 117 switches the operation state to either an activation state of accepting the control signal or a deactivation state of not accepting the control signal. In the present embodiment, the control signal acceptance unit 117 switches from the deactivation state to the activation state when the control signal transmitted by the remote control device 200 to remotely control another vehicle is detected by the detection unit 116. The control signal acceptance unit 117, when in the activation state, accepts the control signal transmitted to the own vehicle. The control signal acceptance unit 117, when in the deactivation state, does not accept the control signal regardless of whether it is a control signal transmitted to the own vehicle or a control signal transmitted to another vehicle. In the following description, the control signal acceptance unit 117 being in the activation state is referred to as a remote control function of the vehicle 100 being in the activation state, and the control signal acceptance unit 117 being in the deactivation state is referred to as the remote control function of the vehicle 100 being in the deactivation state. Switching the remote control function of the vehicle 100 to the deactivation state is referred to as deactivating the remote control function of the vehicle 100, and switching the remote control function of the vehicle 100 to the activation state is referred to as activating the remote control function of the vehicle 100.

When the remote control function of the own vehicle is activated, the notification unit 118 transmits a notification signal for notifying the remote control device 200 that the remote control function of the own vehicle is in the activation state. In the present embodiment, the notification signal includes information indicating that the remote control function of the own vehicle is in the activation state, and the vehicle identification information SJ regarding the own vehicle.

As illustrated in FIG. 1, the remote control device 200 includes a computer provided with a processor 201, a memory 202, an input/output interface 203, and an internal bus 204. The processor 201, the memory 202, and the input/output interface 203 are connected via the internal bus 204 such that they can bidirectionally communicate with each other. A communication device 205 for communicating with the vehicle 100 via wireless communication is connected to the input/output interface 203. In the present embodiment, the communication device 205 can communicate with the external sensor group 300 via wired or wireless communication. The memory 202 stores a computer program PG2 and a target list LS. The target list LS records the vehicle identification information SJ regarding the vehicle 100 to be remotely controlled.

The processor 201 executes the computer program PG2 to thereby function as a remote control unit 210. The remote control unit 210 remotely controls the vehicle 100 recorded in the target list LS. The remote control unit 210 acquires a position and orientation of the vehicle 100 by using the external sensor group 300, generates a control signal for remotely controlling the vehicle 100, and transmits the control signal to the vehicle 100.

The external sensor group 300 includes at least one external sensor. The external sensor is a sensor installed outside the vehicle 100. In the present embodiment, the external sensor group 300 includes a plurality of cameras. Each of the cameras includes a communication device not illustrated and can communicate with the remote control device 200 via wired or wireless communication.

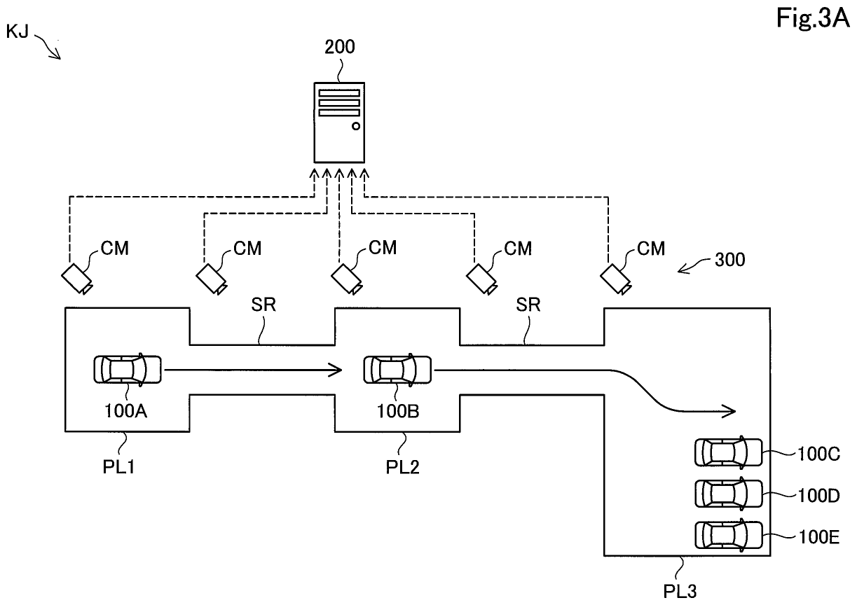

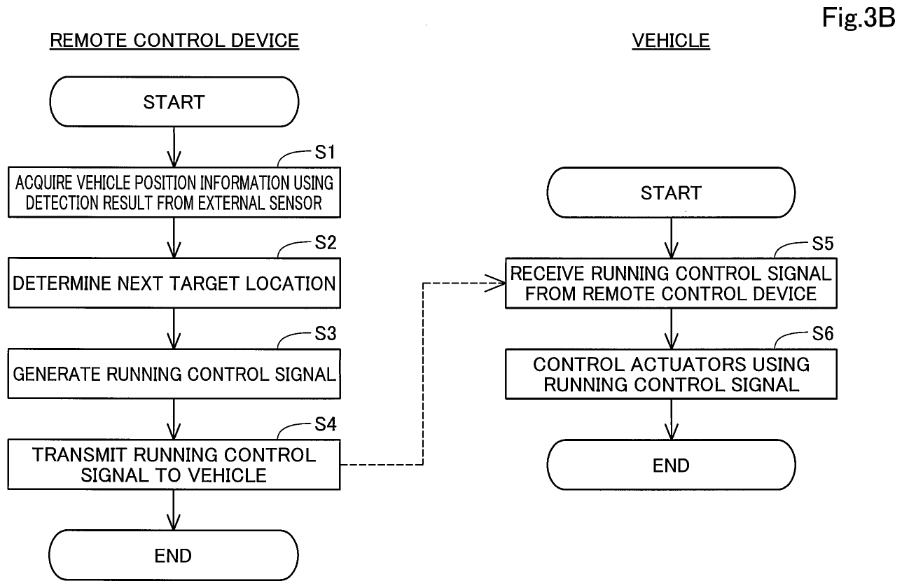

FIG. 3A is an explanatory view illustrating how the vehicle 100 moves by remote control in a factory KJ. FIG. 3A illustrates five vehicles 100A to 100E. In the following description, when the five vehicles 100A to 100E are described without particularly being distinguished from each other, they are simply referred to as the vehicle 100. In the present embodiment, the remote control device 200 is installed in the factory KJ where the vehicle 100 is manufactured. The vehicle 100 is remotely controlled by the remote control device 200 and thereby runs in the factory KJ. The factory KJ includes a first place PL1 for performing an assembly of the vehicle 100, a second place PL2 for performing an inspection of the vehicle 100, and a third place PL3 for storing the vehicle 100 that has passed the inspection. The first place PL1, the second place PL2, and the third place PL3 are connected by a track SR where the vehicle 100 can run. The vehicle control device 110, the actuator group 120, and the communication device 130 are mounted on the vehicle 100 assembled in the first place PL1. The vehicle 100 assembled in the first place PL1 is remotely controlled by the remote control device 200 and thereby runs from the first place PL1 to the second place PL2. The vehicle 100 that has passed the inspection in the second place PL2 is remotely controlled by the remote control device 200 and thereby runs from the second place PL2 to the third place PL3.

A method in which the remote control device 200 moves the vehicle 100 by remote control will be described. The remote control unit 210 included in the remote control device 200 determines a target route for the vehicle 100 to run to a destination through the track SR. In the present embodiment, the target route is a reference route described later. A plurality of cameras CM for capturing the track SR is installed in the factory KJ. The remote control unit 210 analyzes a video captured by each of the cameras CM and thereby can acquire the position and orientation of the vehicle 100 relative to the target route in real time. Each of the cameras CM is included in the external sensor group 300 described above. The remote control unit 210 generates a control signal for causing the vehicle 100 to run along the target route and transmits the control signal to the vehicle 100. The vehicle control device 110 included in the vehicle 100 controls the actuator group 120 according to the received control signal and thereby causes the vehicle 100 to run. This allows to move the vehicle 100 without use of a transport device such as a crane or a conveyor. Note that in the following description, the control signal for causing the vehicle 100 to run may be referred to as a running control signal.

In the present embodiment, the remote control unit 210 causes the plurality of vehicles 100A to 100E one by one to run by remote control. For example, the remote control unit 210 moves the vehicle 100B by remote control from the second place PL2 to the third place PL3 and thereafter switches the remote control target from the vehicle 100B to the vehicle 100A to move the vehicle 100A by remote control from the first place PL1 to the second place PL2. In the present embodiment, the remote control unit 210 can also cause the plurality of vehicles 100A to 100E to simultaneously run in parallel by remote control. For example, it is also possible that the remote control unit 210 moves the vehicle 100B by remote control from the second place PL2 to the third place PL3 and at the same time moves the vehicle 100A by remote control from the first place PL1 to the second place PL2.

Each of the vehicles 100A to 100E that has moved to the third place PL3 is thereafter shipped from the factory KJ. Each of the vehicles 100A to 100E is shipped in a state where the remote control function is reversibly or irreversibly deactivated. To be reversibly deactivated means to be deactivated so that reactivation can be made, and to be irreversibly deactivated means to be deactivated so that reactivation cannot be made. Regarding the vehicle 100 shipped with the remote control function reversibly deactivated, the remote control function is reactivated at a place outside the factory KJ and where the remote control device 200 and the external sensor group 300 are installed, so that the vehicle 100 can run by remote control. The place outside the factory KJ and where the remote control device 200 and the external sensor group 300 are installed is, for example, a park, a commercial facility, or a university.

FIG. 3B is a flowchart illustrating a process procedure of running control of the vehicle 100 in the first embodiment. Step S1 to step S4 are repeatedly executed by the processor 201 of the remote control device 200, whereas step S5 to step S6 are repeatedly executed by the processor 111 of the vehicle control device 110. In the step S1, the remote control device 200 acquires vehicle location information of the vehicle 100 using detection results output from the external sensor, which is a sensor located outside the vehicle 100. The vehicle location information is position information that serves as the basis for generating running control signals. In the present embodiment, the vehicle location information includes the position and orientation of the vehicle 100 in the reference coordinate system of the factory KJ. In the present embodiment, the reference coordinate system of the factory KJ is the global coordinate system, and any location in the factory KJ is expressed with X, Y, and Z coordinates in the global coordinate system. In the present embodiment, the external sensor is the camera CM, and the external sensor outputs a captured image as a detection result. That is, in the step S1, the remote control device 200 acquires the vehicle location information using captured images acquired from the camera CM, which is the external sensor.

More specifically, in step S1, the remote control device 200 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system, thereby acquiring the location of the vehicle 100. The outer shape of the vehicle 100 in the captured image may be detected by inputting the captured image to a detection model using artificial intelligence, for example. The detection model is prepared in the remote control system 10 or outside the remote control system 10. The detection model is stored in advance in the memory 202 of the remote control device 200, for example. An example of the detection model is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 100 or a region indicating a subject other than the vehicle 100, for example. In training the CNN, a parameter for the CNN is preferably updated through backpropagation in such a manner as to reduce error between output result obtained by the detection model and the label. The remote control device 200 can acquire the orientation of the vehicle 100 through estimation based on the direction of a motion vector of the vehicle 100 detected from change in location of a feature point of the vehicle 100 between frames of the captured images using optical flow process, for example.

In step S2, the remote control device 200 determines a target location to which the vehicle 100 is to move next. In the present embodiment, the target location is expressed by X, Y, and Z coordinates in the global coordinate system. The memory 202 of the remote control device 200 contains the reference route RR stored in advance as a route along which the vehicle 100 is to run. The route is expressed by a node indicating a departure place, a node indicating a way point, a node indicating a destination, and a link connecting nodes to each other. The remote control device 200 determines the target location to which the vehicle 100 is to move next using the vehicle location information and the reference route RR. The remote control device 200 determines the target location on the reference route RR ahead of a current location of the vehicle 100.

In step S3, the remote control device 200 generates a running control signal for causing the vehicle 100 to run toward the determined target location. In the present embodiment, the running control signal includes an acceleration and a steering angle of the vehicle 100 as parameters. The remote control device 200 calculates a running speed of the vehicle 100 from transition of the location of the vehicle 100 and makes comparison between the calculated running speed and a target speed of the vehicle 100 determined in advance. If the running speed is lower than the target speed, the remote control device 200 generally determines an acceleration in such a manner as to accelerate the vehicle 100. If the running speed is higher than the target speed as, the remote control device 200 generally determines an acceleration in such a manner as to decelerate the vehicle 100. If the vehicle 100 is on the reference route RR, The remote control device 200 determines a steering angle and an acceleration in such a manner as to prevent the vehicle 100 from deviating from the reference route RR. If the vehicle 100 is not on the reference route RR, in other words, if the vehicle 100 deviates from the reference route RR, the remote control device 200 determines a steering angle and an acceleration in such a manner as to return the vehicle 100 to the reference route RR. In other embodiments, the running control signal may include the speed of the vehicle 100 as a parameter instead of or in addition to the acceleration of the vehicle 100.

In step S4, the remote control device 200 transmits the generated running control signal to the vehicle 100. The remote control device 200 repeats the acquisition of vehicle location information, the determination of a target location, the generation of a running control signal, the transmission of the running control signal, and others in a predetermined cycle.

In step S5, the vehicle control device 110 of the vehicle 100 receives the running control signal transmitted from the remote control device 200. In step S6, the vehicle control device 110 controls the actuator group 120 using the received running control signal, thereby causing the vehicle 100 to run at the acceleration and the steering angle indicated by the running control signal. The vehicle control device 110 repeats the reception of a running control signal and the control over the actuator group 120 in a predetermined cycle.

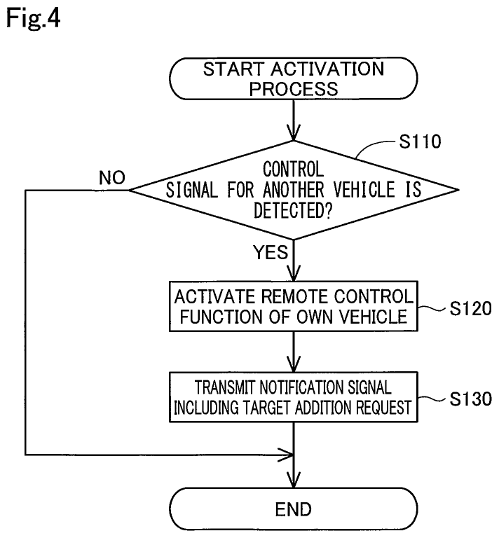

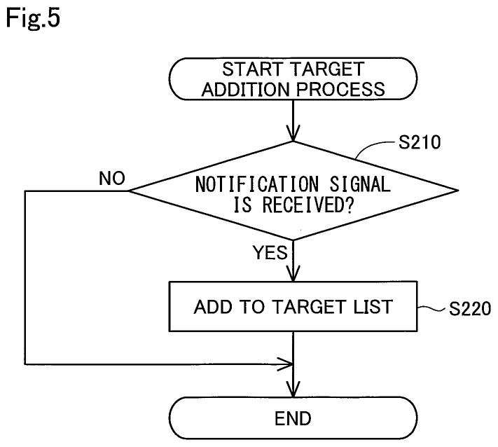

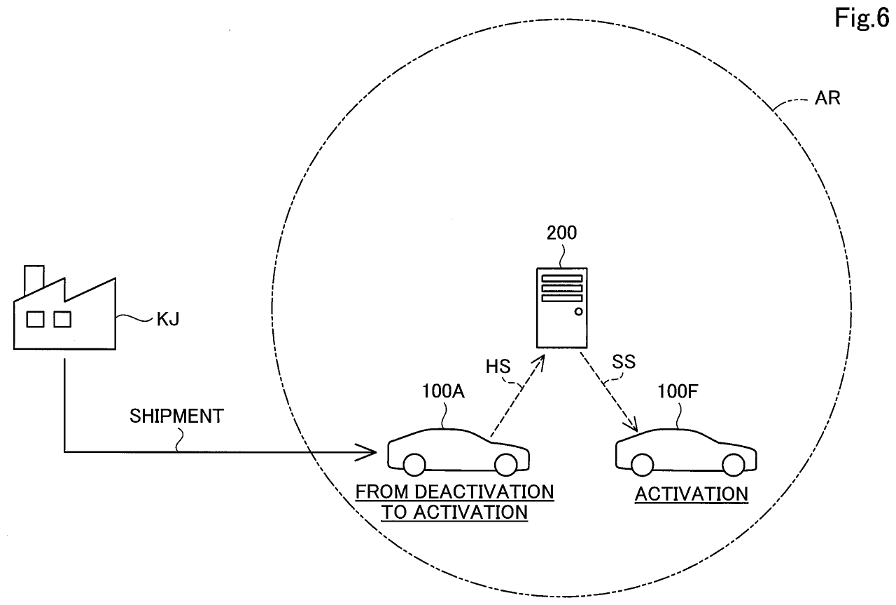

FIG. 4 is a flowchart illustrating contents of an activation process executed in the vehicle 100 in which the remote control function is reversibly deactivated. FIG. 5 is a flowchart illustrating contents of a target addition process executed in the remote control device 200. FIG. 6 is an explanatory view illustrating how the remote control function of the vehicle 100 is activated. A remote control method of the vehicle 100 will be described with reference to FIGS. 4 to 6.

The activation process illustrated in FIG. 4 is repeatedly executed by the vehicle control device 110 equipped in the vehicle 100. Upon start of the activation process, the detection unit 116 determines in step S110 whether the control signal transmitted by the remote control device 200 to remotely control another vehicle is detected. When it is not determined in step S110 that the control signal transmitted by the remote control device 200 to remotely control another vehicle is detected, the vehicle control device 110 skips the processing after step S110 and ends the activation process. When it is determined in step S110 that the control signal transmitted by the remote control device 200 to remotely control another vehicle is detected, the control signal acceptance unit 117 switches from the deactivation state to the activation state in step S120. In other words, the remote control function of the own vehicle switches to the activation state in step S120. In step S130, the notification unit 118 transmits the notification signal of notifying that the remote control function of the own vehicle is in the activation state. In the present embodiment, the notification signal includes the vehicle identification information SJ regarding the own vehicle, information indicating that the remote control function of the own vehicle is in the activation state, and a target addition request for requesting addition of the own vehicle to the target list LS of the remote control device 200. Thereafter, the vehicle control device 110 ends the activation process. Note that step S110 may be referred to as a detection step, step S120 may be referred to as a switching step, and step S130 may be referred to as a notification step.

The target addition process illustrated in FIG. 5 is repeatedly executed by the remote control device 200. Upon start of the target addition process, the remote control unit 210 determines in step S210 whether the notification signal is received. When it is not determined in step S210 that the notification signal is received, the remote control unit 210 skips the processing after step S210 and ends the target addition process. When it is determined in step S210 that the notification signal is received, the remote control unit 210 adds to the target list LS the vehicle 100 that has transmitted the notification signal, in step S220. In the present embodiment, the remote control unit 210 adds to the target list LS the vehicle identification information SJ regarding the vehicle 100 that is included in the notification signal. Thereafter, the remote control device 200 ends the target addition process.

As illustrated in FIG. 6, when the vehicle 100A shipped from the factory KJ with the remote control function reversibly deactivated moves to a place AR outside the factory KJ and where the remote control device 200 is installed, and receives a control signal SS for the remote control device 200 to remotely control another vehicle 100F, the remote control function of the vehicle 100A is automatically activated by the activation process. The vehicle 100A in which the remote control function has been activated transmits a notification signal HS including the target addition request. The remote control device 200 that has received the notification signal HS adds the vehicle 100A to the target list LS through the target addition process. The remote control device 200 determines the target route of the vehicle 100A added to the target list LS and thereby prepares move of the vehicle 100A by remote control. Thereafter, the remote control device 200 generates a control signal for remotely controlling the vehicle 100A and transmits the control signal to the vehicle 100A. The remote control device 200 transmitting the control signal to the vehicle 100A starts move of the vehicle 100A by remote control.

According to the remote control system 10 in the present embodiment described above, when the vehicle 100 in which the remote control function has been reversibly deactivated detects the control signal SS transmitted from the remote control device 200 for remotely controlling another vehicle, the remote control function of the vehicle 100 is automatically activated. This allows the vehicle 100 to be operable by remote control without taking user's labor.

### B. Second Embodiment

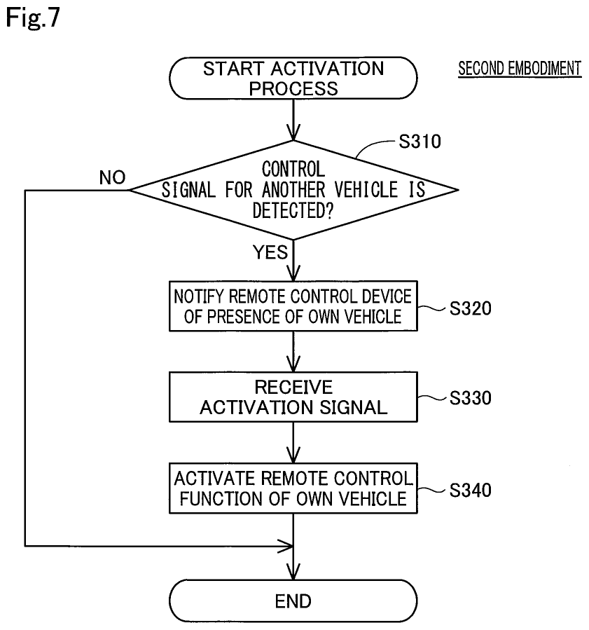

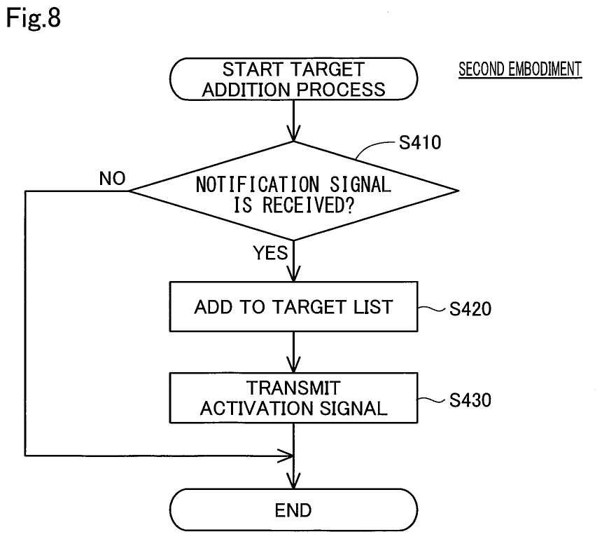

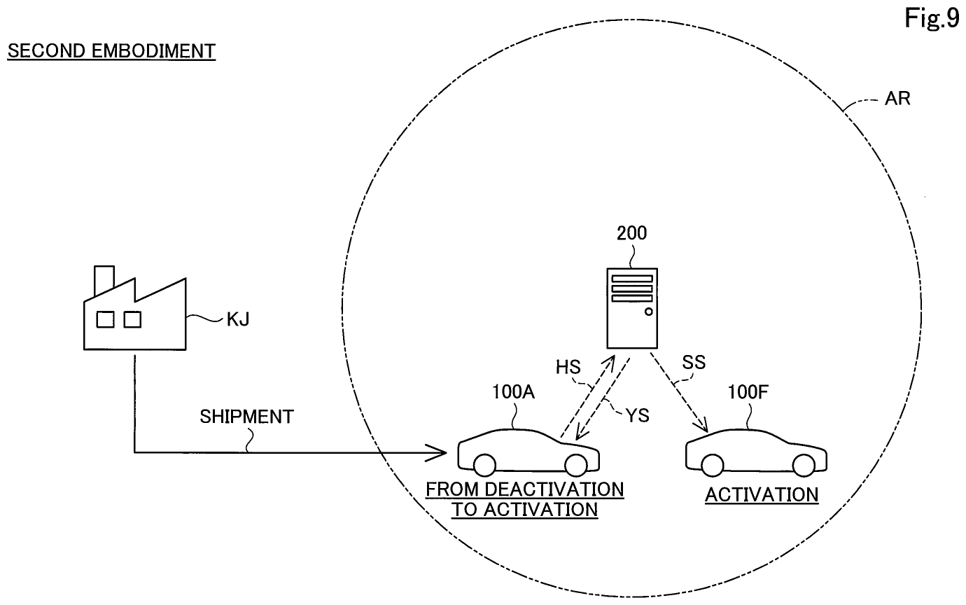

FIG. 7 is a flowchart illustrating contents of an activation process executed in a remote control system 10b of a second embodiment. FIG. 8 is a flowchart illustrating contents of a target addition process executed in the remote control system 10b of the second embodiment. FIG. 9 is an explanatory view illustrating how the remote control function of the vehicle 100 is activated in the remote control system 10b of the second embodiment. The remote control system 10b of the second embodiment differs from that of the first embodiment in that when the vehicle 100 receives an activation signal from the remote control device 200, the remote control function of the vehicle 100 is activated. The other configurations are the same as those of the first embodiment, unless otherwise specified.

Upon start of the activation process illustrated in FIG. 7, the detection unit 116 determines in step S310 whether the control signal transmitted by the remote control device 200 to remotely control another vehicle is detected. When it is not determined in step S310 that the control signal transmitted by the remote control device 200 to remotely control another vehicle is detected, the vehicle control device 110 skips the processing after step S310 and ends the activation process. When it is determined in step S310 that the control signal transmitted by the remote control device 200 to remotely control another vehicle is detected, the notification unit 118 transmits a notification signal for notifying the remote control device 200 of the presence of the own vehicle in step S320. In the present embodiment, the notification signal includes the vehicle identification information SJ regarding the own vehicle. In step S330, the control signal acceptance unit 117 acquires the activation signal transmitted from the remote control device 200 according to the notification signal. In step S340, the control signal acceptance unit 117 switches from the deactivation state to the activation state according to the activation signal. Thereafter, the vehicle control device 110 ends the activation process. Note that step S310 may be referred to as a detection step, step S320 may be referred to as a notification step, and steps S330 to S340 may be referred to as a switching step.

Upon start of the target addition process illustrated in FIG. 8, the remote control unit 210 determines in step S410 whether the notification signal is received. When it is not determined in step S410 that the notification signal is received, the remote control unit 210 skips the processing after step S410 and ends the target addition process. When it is determined in step S410 that the notification signal is received, the remote control unit 210 adds to the target list LS the vehicle 100 that has transmitted the notification signal, in step S420. In step S430, the remote control unit 210 transmits the activation signal for activating the remote control function of the vehicle 100 that has transmitted the notification signal. Thereafter, the remote control device 200 ends the target addition process.

As illustrated in FIG. 9, when the vehicle 100A shipped from the factory KJ with the remote control function reversibly deactivated moves to the place AR outside the factory KJ and where the remote control device 200 is installed, and receives the control signal SS for the remote control device 200 to remotely control another vehicle 100F, the vehicle 100A transmits the notification signal HS for notifying the remote control device 200 of the presence of the vehicle 100A through the activation process. The remote control device 200 that has received the notification signal HS adds the vehicle 100A to the target list LS through the target addition process and transmits an activation signal YS for activating the remote control function of the vehicle 100A. When the vehicle 100A receives the activation signal YS, the remote control function of the vehicle 100A is automatically activated. The remote control device 200 prepares or starts move of the vehicle 100A added to the target list LS by remote control.

According to the remote control system 10b in the present embodiment described above, when the vehicle 100 in which the remote control function has been reversibly deactivated detects the activation signal YS transmitted from the remote control device 200, the remote control function of the vehicle 100 is automatically activated. This allows the vehicle 100 to be operable by remote control without taking user's labor.

### C. Other Embodiments

(C1) According to the remote control systems 10 to 10b of the respective embodiments described above, when the detection unit 116 detects the control signal transmitted by the remote control device 200 to remotely control another vehicle, the remote control function of the vehicle is activated. In contrast, when the detection unit 116 detects the control signal transmitted by the remote control device 200 to remotely control the own vehicle, the remote control function of the vehicle 100 may be activated. When the detection unit 116 detects not the control signal but a signal merely indicating that the remote control device 200 is in operation, the remote control function of the vehicle may be activated. The signal indicating that the remote control device 200 is in operation may be transmitted from a device other than the remote control device 200.

(C2) In the remote control system 10 of the first embodiment described above, the vehicle control device 110 may not include the notification unit 118. In this case, the vehicle identification information SJ regarding the vehicle 100 may be added to the target list LS by, for example, the user operating an input device connected to the remote control device 200.

(C3) In the remote control systems 10 to 10b of the respective embodiments described above, the external sensor is not limited to the camera but may be the distance measuring device, for example. The distance measuring device is a light detection and ranging (LiDAR) device, for example. In this case, detection result output from the external sensor may be three-dimensional point cloud data representing the vehicle 100. The remote control device 200 and the vehicle 100 may acquire the vehicle location information through template matching using the three-dimensional point cloud data as the detection result and reference point cloud data, for example.

(C4) In the remote control systems 10 to 10b of the respective embodiments described above, the remote control device 200 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.

(1) The remote control device 200 may acquire vehicle location information, determine a target location to which the vehicle 100 is to move next, and generate a route from a current location of the vehicle 100 indicated by the acquired vehicle location information to the target location. The remote control device 200 may generate a route to the target location between the current location and a destination or generate a route to the destination. The remote control device 200 may transmit the generated route to the vehicle 100. The vehicle 100 may generate a running control signal in such a manner as to cause the vehicle 100 to run along the route received from the remote control device 200 and control the actuator group 120 using the generated running control signal.

(2) The remote control device 200 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control the actuator group 120 using the generated running control signal.

(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the remote control device 200 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.

(C5) In the remote control systems 10 to 10b of the respective embodiments described above, the remote control device 200 automatically generates a running control signal to be transmitted to the vehicle 100. By contrast, the remote control device 200 may generate a running control signal to be transmitted to the vehicle 100 in response to operation by an external operator existing outside the vehicle 100. For example, the external operator may operate an operating device including a display on which a captured image output from the external sensor is displayed, steering, an accelerator pedal, and a brake pedal for operating the vehicle 100 remotely, and a communication device for making communication with the remote control device 200 through wire communication or wireless communication, for example, and the remote control device 200 may generate a running control signal responsive to the operation on the operating device.

(C6) In each of the above-described embodiments, the vehicle 100 is simply required to have a configuration to become movable by unmanned driving. The vehicle 100 may embodied as a platform having the following configuration, for example. The vehicle 100 is simply required to include at least the vehicle control device 110 and the actuator group 120 in order to fulfill three functions including “run,” “turn,” and “stop” by unmanned driving. In order for the vehicle 100 to acquire information from outside for unmanned driving, the vehicle 100 is simply required to include the communication device 130 further. Specifically, the vehicle 100 to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 100 before the vehicle 100 is shipped from the factory KJ, or a remaining component such as a bodyshell may be mounted on the vehicle 100 after the vehicle 100 is shipped from the factory KJ while the remaining component such as a bodyshell is not mounted on the vehicle 100. Each of components may be mounted on the vehicle 100 from any direction such as from above, from below, from the front, from the back, from the right, or from the left. Alternatively, these components may be mounted from the same direction or from respective different directions. The location determination for the platform may be performed in the same way as for the vehicle 100 in the first embodiments.

(C7) The vehicle 100 may be manufactured by combining a plurality of modules. The module means a unit composed of one or more components grouped according to a configuration or function of the vehicle 100. For example, a platform of the vehicle 100 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100 different from the platform may be modularized. Various modules may include an arbitrary exterior component such as a bumper or a grill, or an arbitrary interior component such as a seat or a console. Not only the vehicle 100 but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

(C8) A configuration for realizing running of a vehicle by unmanned driving is also called a “Remote Control auto Driving system”. Conveying a vehicle using Remote Control Auto Driving system is also called “self-running conveyance”. Producing the vehicle using self-running conveyance is also called “self-running production”. In self-running production, for example, at least part of the conveyance of vehicles is realized by self-running conveyance in a factory where the vehicle is manufactured.

(C9) The control and the method described in the present disclosure may be realized by a dedicated computer provided by configuring a processor and a memory programmed in such a manner as to implement one or a plurality of functions embodied by a computer program. Alternatively, the controller and the method described in the present disclosure may be realized by a dedicated computer provided by configuring a processor using one or more dedicated hardware logic circuits. Still alternatively, the controller and the method described in the present disclosure may be realized by one or more dedicated computers configured using a combination of a processor and a memory programmed in such a manner as to implement one or a plurality of functions, and a processor configured using one or more hardware logic circuits. The computer program may be stored as an instruction to be executed by a computer into a computer-readable tangible non-transitory recording medium.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof.

What is claimed is:

1. A moving object operable by remote control, comprising:
a detection unit configured to detect a signal transmitted from a control device for remotely controlling the moving object; and
a control signal acceptance unit configured to switch to either an activation state of accepting a control signal transmitted from the control device for remotely controlling the moving object or a deactivation state of not accepting the control signal, wherein the control signal acceptance unit switches to the activation state when the signal is detected by the detection unit.

2. The moving object according to claim 1, wherein
the signal is a control signal for remotely controlling another moving object different from the moving object.

3. The moving object according to claim 1, further comprising a notification unit configured to transmit a notification signal for notifying the control device that the control signal acceptance unit has switched to the activation state.

4. A remote control system, comprising:
a moving object operable by remote control; and
a control device for remotely controlling the moving object,
wherein the moving object includes,
a detection unit configured to detect a signal transmitted from the control device,
a control signal acceptance unit configured to switch to either an activation state of accepting a control signal transmitted from the control device for remotely controlling the moving object or a deactivation state of not accepting the control signal, wherein the control signal acceptance unit switches to the activation state when the signal is detected by the detection unit, and
a notification unit configured to transmit a notification signal for notifying the control device that the control signal acceptance unit has switched to the activation state, and
wherein the control device prepares or starts remote control for the moving object when receiving the notification signal.

5. A remote control method, comprising:
detecting a signal transmitted from a control device for remotely controlling a moving object; and
switching to either an activation state of accepting a control signal transmitted from the control device for remotely controlling the moving object or a deactivation state of not accepting the control signal, switching switches to the activation state when the signal is detected by detecting.
